(19) United States
(12) Patent Application Publication
(10) Pub. No.: US 2012/0232734 A1
(43) Pub. Date: Sep. 13, 2012

(54) MOTOR-DRIVEN VEHICLE

(76) Inventor: Stephane Pelletier, Paris (FR)

(21) Appl. No.: 13/394,964

(22) PCT Filed: Sep. 9, 2010
(86) PCT No.: PCT/FR2010/051882

§ 371 Date: May 22, 2012

(30) Foreign Application Priority Data
Sep. 9, 2009 (FR) 0956154

(51) Int. Cl. A63C 17/12; B60L 15/00

(52) U.S. Cl. 701/22; 180/181

(57) ABSTRACT

A motor-driven vehicle includes front and rear wheels suitable for enabling the movement thereof through rolling; a structure extending between the front and rear wheels, the structure being suitable for supporting the feet of a user in a standing position on the vehicle; at least one electric motor rotating at least one of the wheels; and a device for managing the electrical power supply for the at least one electric motor. The vehicle comprises first and second bearing areas for feet, the second bearing area having a sensitivity specific thereto, and the power supply management device is suitable for generating an electrical power supply signal from the motor that is variable on the basis of the bearing detected in the second bearing area.

### BACKGROUND

This invention relates, in general, to the field of vehicle control by a user.

More specifically, the invention relates to a powered vehicle, including:
front and rear wheels suitable for supporting the vehicle with respect to the ground and for enabling it to move by rolling (on the ground);
a structure extending between the front and rear wheels, and over a major portion of the length of the vehicle, which structure is suitable for supporting the feet of a user in the standing position on the vehicle;
at least one electric motor driving at least one of said wheels in rotation;
means for managing the electrical supply to said at least one electric motor.

This type of vehicle is preferably a skateboard powered by means of at least one electrical motor.

### SUMMARY OF THE INVENTION

In this context, this invention is intended to propose a vehicle of which the user control ergonomics are improved.

To this end, the vehicle of the invention, also consistent with the general definition provided in the preamble above, is essentially characterized in that it comprises at least first and second areas for contact of the feet of the user in the standing position on the vehicle, and said second contact area has at least one specific sensitivity and said power supply management means are suitable for generating an electrical power supply signal Sm of said motor that is variable according to the contact detected at the level of said second contact area.

Owing to the invention, the user can cause the electrical power supply signal of the motor to vary by simply pressing on the second sensitive area, which detects a parameter representing the contact, such as a pressure or a force. The motor command signal is then a function of this detection.

To implement the vehicle according to the invention, it is also possible to have the second sensitive contact area extend over at least 20% of the length of said vehicle, and preferably said second sensitive contact area extending over a length of between 30% and 60% of the length of said vehicle.

With such a length, the user can control the vehicle while maintaining the possibility of moving the contacts over the structure, and has great freedom of movement while preserving his or her ability to control the vehicle.

To implement the vehicle according to the invention, it is possible for each of said first and second contact areas to have at least one specific sensitivity and for said power supply management means to be capable of generating an electrical power supply signal Sm of said motor, which is variable according to the distribution of at least some of the weight of the user on said first and second contact areas.

With this embodiment, the user can cause the electrical power supply signal of the motor and therefore the speed of the vehicle to vary simply by changing the distribution of all or some of his or her weight in the areas of the contact areas that are formed on the structure. Such a vehicle is therefore particularly ergonomic and easy to use, with the human/machine interface being primarily at the level of the contact of the user in the standing position on the structure. The user therefore does not need to hold a vehicle control between his or her hands, as his or her contact on the vehicle is enough to finely control the vehicle.

The sensitivity is the ability of a given contact area to detect contact and to generate a signal representing this contact.

Thus, low sensitivity means that the amplitude value measured is high in order to be detected and signaled. By contrast, high sensitivity means that, for an amplitude measured with a low intensity, a signal representing this measured low intensity is similarly obtained.

To implement the invention, it is also possible for the second contact area to have a sensitivity so that it enables a contact force exerted by the user on all or some of this second contact area to be measured.

In this case, the distribution of contacts between the first and second areas is achieved by means of measurements coming from sensitive contact measurement means in the second contact area and by means of at least one signal of the presence of a user on the vehicle, which in this embodiment serves as sensitive contact measurement means in the first contact area, with this first contact area extending over a major portion of the length of the structure.

Owing to this embodiment, the means for detecting the presence of a user on the vehicle serve as sensitive means of the first sensitive contact area, thereby enabling the number of sensitive contact measurement means to be limited.

For the implementation of the invention, it is also possible for the powered vehicle to comprise a third area of contact of the foot of the user in a standing position on the vehicle, with this third contact area also having a specific sensitivity, in which the means for managing the power supply of the motor are suitable for causing said power supply signal of said motor to vary according to the distribution of at least some of the weight of the user on at least two of said first, second and third contact areas.

The use of three contact areas in order to measure the distribution of the weight of the user between these three areas makes it possible to improve the ergonomics of the vehicle according to the invention because the user can cause the power supply signal of the motor to be varied by distributing his or her contact over the three sensitive areas. The human/machine interface thus comprises new means for controlling the vehicle accessible by the contact of the user in the standing position on the structure.

For the implementation of the invention, it is also possible for the powered vehicle to comprise an intermediate contact area for the foot of the user located between the second and third areas and having a width at least greater than 5 centimeters.

Owing to this intermediate contact area, the user can place one foot and be in contact with the structure between these second and third sensitive areas without being in contact with these second and third areas. For this, the intermediate contact area has a width preferably between 5 and 20 centimeters and preferably between 10 and 20 centimeters, which enables a foot of an adult user to be placed without it being detected by the first and third sensitive areas.

For the implementation of the invention, it is also possible for the powered vehicle to comprise means for detecting the presence of a user on the vehicle, suitable for generating a signal for detecting the presence of a user on the vehicle.

The detection of the presence of a user on the vehicle can be useful for authorizing the starting of the vehicle only when the user is present on the vehicle.

As explained below, these presence detection means can comprise a sensor for sensing a bend in the vehicle structure, in which the value of the bend is dependent on the presence of the user on the vehicle.

For the implementation of the invention, it is also possible for the means for managing the power supply of the motor to be suitable, in the event of the detection of the presence of a user on the vehicle and in the event of non-detection of the contact of the user on the second contact area, for generating a signal for emergency deceleration of the vehicle so that the motor generates a braking torque of the vehicle until it stops.

This embodiment is advantageous because the user in the standing position on the vehicle can simply control the emergency braking of the vehicle by removing his or her foot from the second contact area.

In the embodiments of the invention in which the vehicle comprises a so-called third contact area for the foot of the user, the means for managing the power supply of the motor are suitable, in the event of the detection of the presence of the user and in the event of non-detection of contact of the user on the second and third contact areas simultaneously, for generating said signal for emergency deceleration of the vehicle.

This particular embodiment is advantageous if the vehicle of the invention comprises said intermediate contact area for the foot of the user located between the second and third areas, because it is then sufficient for the user to position his or her foot in the intermediate area by being careful not to press at least one of the second and third areas so that the vehicle will brake.

For the implementation of the invention, it is also possible for the means for managing the power supply of the motor to be suitable so that, if there is no detection of the presence of the user on the vehicle by said presence detection means, the means for managing the power supply of the motor will generate a deceleration signal indicating that the user has fallen, so that the motor will generate a braking torque of the vehicle until it stops.

This embodiment makes it possible to have a braking function specific to a case in which the user falls.

For the implementation of the invention according to the previous two embodiments combined, it is also possible for the signals for emergency deceleration and deceleration for a user fall to be adapted so that the complete stopping time of the motor is shorter in response to the signal for deceleration for a user fall than it is in response to the emergency deceleration signal.

This embodiment makes it possible to maximize the stopping speed of the vehicle in the event of a user fall, because the movement of the vehicle without the user could be dangerous, while enabling an emergency stop when the user is still on the vehicle. The emergency braking with the user on the vehicle is thus achieved over a period of time sufficient to reduce the risk of a fall by the user during the emergency braking stop.

For the implementation of the invention, it is also possible for the powered vehicle to comprise at least one wheel train to which one of said front or rear wheels of the vehicle belongs, in which said at least one wheel train is movably mounted with respect to the structure, between right steering and left steering positions of the vehicle, in which the mobility of said at least one wheel train is suitable for adopting a steering position according to a tilting position of said structure with respect to the ground on which said vehicle is moving.

This embodiment is advantageous because it enables the user to choose the direction of movement of the vehicle by tilting of the structure, owing to the user's contact with the board. Owing to the user's own contact, he or she manages the direction and the speed/acceleration of the vehicle.

For the implementation of the invention, it is also possible for at least one of the contact areas to include a plate defining a contact surface of said at least one contact area, in which said plate is arranged on an upper face of the structure and is mobile with respect to the structure, and the vehicle comprises at least one sensor of at least one physical parameter representing a force applied on said plate, which sensor is connected to said means for managing the power supply so as to transmit a signal thereto representing a force applied on said plate, in which said sensor of at least one physical parameter is placed between said plate and the structure.

Such a plate enables a detection of contact while protecting the sensor from external aggravations, such as, for example, shocks, water sprays and falling objects. In addition, such a plate enables a large detection surface to be defined by means of standard commercial-sized sensors.

Preferably, the plate of a given contact area is pivotably connected to the structure and said sensor of a physical parameter is a force or pressure sensor and forms a stop on which the plate rests. This embodiment is particularly advantageous because it makes it possible for a force to be detected at the level of the sensor, which increases in a manner inversely proportional to the distance between the sensor and the point of application of force on the plate.

Thus, the user can cause the power supply signal transmitted to the motor to vary according to:
the position of the point of contact on the plate; and
the value of the force.

The ergonomics of the vehicle are improved because it is possible to obtain the same value for the power supply signal at a plurality of points on the plate simply by adjusting the contact force on the plate.

As an alternative to the embodiments in which a sensitive contact area includes a plate and a sensor placed between the plate and the structure, it is possible for at least one of the contact areas to comprise a mat for detecting pressures applied on said mat and suitable for transmitting, to said power supply management means, a signal representing the intensity of the force applied on said contact area and the location of application of force on said contact area.

Preferably, the first and second contact areas extend in the same plane, and preferably the third contact area and preferably the intermediate area also extend in this same plane. The coplanar aspect of the sensitive or non-sensitive contact areas is advantageous because the user can easily move his or her contact from one area to the other, without any obstacles; moreover, the movement in a plane enables balance to be maintained more easily than if the contacts had non-coplanar forms. To make this preferred embodiment easier to understand, contact areas are considered to be coplanar if they extend between two parallel planes separated by a distance of no more than one centimeter.

The invention also relates to a method for controlling a powered vehicle according to any one of the aforementioned embodiments, characterized in that it comprises:
a step of measuring a physical parameter representing an intensity of contact on said second contact area; and
a step of generating the power supply signal Sm of said motor, which is dependent on the measured physical parameter and representing an intensity of contact on said second contact area.

For the implementation of the method of the invention, it is also possible to perform a step of evaluating the distribution of the contacts of the feet of the user in the standing position on the first and second respective foot contact areas of the vehicle at least by said measurement of the physical parameter, and for the step of generating the power supply signal Sm of said motor to be performed according to the evaluated contact distribution, i.e. according to the detected distribution of at least some of the weight of the user on said first and second contact areas.

The evaluation of the distribution of contacts of the user, even with a degree of uncertainty inherent to the measurement, is an estimation of the distribution of contacts that is adequate to enable the user to control the vehicle. The control by movement of the contact pints or forces applied on the contact areas is particularly ergonomic.

The precision of the contact distribution evaluation can be improved by using at least first and second sensitive contact areas.

For the implementation of the method of the invention, it is also possible to perform a step of measuring a physical parameter representing a current speed of said vehicle, such as the current rotation speed of the motor, and for the power supply signal of said motor also to be calculated as a function of said physical parameter representing a current speed of said vehicle so as to cause the speed of the vehicle to move toward a set point speed value calculated as a function of said detected distribution of contacts of the feet of the user.

In this embodiment, the vehicle is controlled in a closed loop and the means for generating the motor command signal take into account the speed of the vehicle in order to generate the signal, which prevents decoupling of the control signal from the real behavior of the vehicle. This embodiment therefore makes it possible to control the power delivered to the motor by taking into account the set point to be respected and the energy required to reach said set point speed in a given environment of the vehicle (when going downhill, the control signal of the motor may cause braking so as to prevent the set point from being exceeded, and when going uphill, the control signal of the motor may produce an additional power force so as to reach the set point).

For the implementation of the method of the invention, it is also possible for the method to include a step of parameterization of said vehicle by determining at least one parameter influencing the sensitivity specific to at least one of said first and second contact areas and the storage of said at least one sensitivity-influencing parameter, and for said power supply signal of said motor also to be calculated as a function of said previously stored sensitivity-influencing parameter.

In this embodiment, the sensitivity of the contact areas is determined, which is advantageous because the user can thus have a vehicle of which the reactions to his or her orders (contact force and position) can be adjusted as needed. For example, an experienced user may want a higher degree of sensitivity enabling him or her to have greater driving finesse. By contrast, a beginning user may want to have reduced sensitivity so that his or her driving errors will not be excessively amplified, thus reducing the risk of falling.

Preferably, for the implementation of the method of the invention, the step of detecting a physical parameter representing the distribution of contacts of the feet of the user in the standing position is performed by taking into account signals coming from the respective second and third foot contact areas of the vehicle and prerecorded data representing the weight of the user of said vehicle.

In this embodiment with the signals generated by the second and third contact areas, knowing the data representing the user's weight, the distribution of contact between the first contact area and the second and third contact areas is determined.

Preferably, the method comprises a step of summing the signals generated by the second and third contact areas, then a step of comparing the result of this summation with said prerecorded data representing the weight of the user of said vehicle. This embodiment makes it possible to known the distribution of contacts between the first contact area, of zero or positive sensitivity (according to the embodiment) and a group of contact areas constituted by the second and third contact areas. In addition, owing to this embodiment, the signals coming from the second and third contact areas are taken into account with the same level of importance, thus authorizing an identical response of the vehicle to equivalent contacts on the second and third contact areas. This symmetry of behavior in particular enables the vehicle to be used by people with either right- or left-side dominance.

For the implementation of the method of the invention, it is also possible, in order to determine said sensitivity-influencing parameter, to evaluate the weight of the user of said vehicle by means of a vehicle load sensor and/or by means of the sensor of physical parameters representing contacts on said second and third sensitive contact areas.

Preferably, in order to evaluate the user's weight, a measurement is obtained by means of the vehicle load sensor and/or by means of sensors of physical parameters representing contacts on said second sensitive contact areas, when the user is absent from the vehicle and a value representing the empty load of the vehicle is stored, and another measurement is obtained by means of said vehicle load sensor and/or by means of at least one sensor of a physical parameter representing contact on said second sensitive contact area, when the user is present on the vehicle and a value representing the load of the vehicle in the presence of the user is stored, and said sensitivity-influencing parameter is determined as a function of said values representing the vehicle load and/or as a function of values representing a maximum contact detected at the level of said second sensitive area.

For the implementation of the method of the invention, it is also possible for said load sensor to be a sensor for sensing a bend, assembled to the structure of the vehicle and suitable for measuring a degree of bending of the structure, in which said degree of bending varies as a function of the load on the vehicle.

An advantage of such a sensor is that it is strong and can be integrated with the surface of the structure without having to weaken said structure in order to implant the sensor.

Preferably, the vehicle of the invention comprises a calculator suitable for implementing the step of parameterization of the vehicle, in which said calculator is such that it defines the sensitivity or sensitivities specific to the first and/or second and/or third sensitive contact area(s) so that a specific given sensitivity is lower for a user of higher weight and higher for a user of lower weight.

In this case, the sensitivity-influencing parameter is a coefficient multiplying the signal transmitted by at least one of the first and/or second and/or third sensitive contact areas.

Preferably, the bend sensor that is assembled to the structure of the vehicle is also one of the means for detecting the presence of a user.

### BRIEF DESCRIPTION OF THE DRAWINGS

Other features and advantages of the invention will become clear from the following description, provided for indicative and entirely non-limiting purposes, in reference to the appended drawings, in which:

FIG. 1 shows a perspective view of the vehicle according to the invention that is, in this case, an electric skateboard;

FIG. 2 shows a transverse cross-section view A-A of the vehicle of the invention of FIG. 1 in which a front-wheel motor and a rear-wheel train are visible;

FIG. 3 shows a diagrammatic view of the vehicle of the invention in which the first, second and third sensitive contact areas 6a, 6b and 6c and an intermediate contact area 6d located between the first and third sensitive areas are visible (the first contact area, which extends over a major portion of the length of the vehicle is indirectly sensitive owing to the means for detecting the presence of a user on the vehicle J);

FIG. 4 is a table showing the different states of the vehicle of the invention (the line “Sm” indicates the power supply signal of the motor), as a function of:
signals transmitted by the means for detecting the presence J of a user on the vehicle and conferring a sensitivity on the first sensitive contact area 6a;
signals S1 and S2 coming respectively from the second and third sensitive areas 6b, 6c, which signals S1, S2 represent respective forces applied on said second and third respective areas;

FIG. 5a, which shows the three coils of the three-phase motor of the vehicle according to the invention as well as the voltages R, G, B measured at the respective terminals of these coils and a power supply cycle of these coils of the motor over time, in which the cycle has six steps each taking place over one-sixth of a rotation of the motor;

FIG. 5b, which shows the power supply cycle of the coils of the motor over one motor rotation (i.e. during the six phases of FIG. 5a); this FIG. 5b has three voltage curves R, G, B corresponding respectively to the power supply voltages of the three respective coils, and these three curves represent components of the power supply signal of the motor.

### DETAILED DESCRIPTION OF THE PREFERRED EMBODIMENT(S)

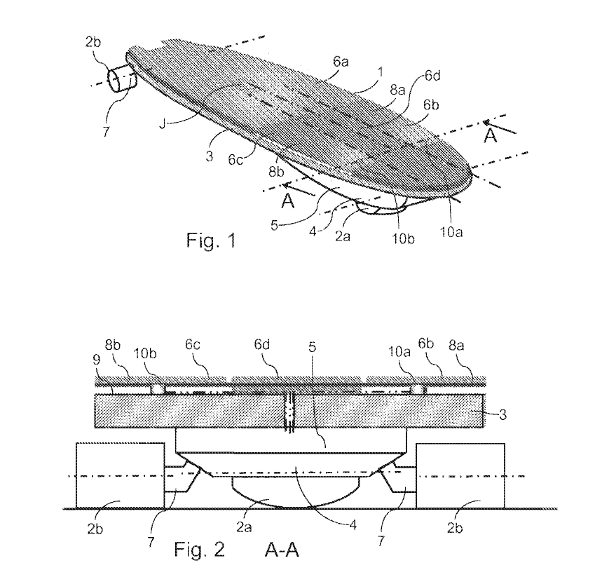

As shown in FIG. 1, the invention relates to a vehicle with an electric motor, including:

a front wheel 2a and a motor 4 integrated in the wheel and forming a wheel motor;

a rear wheel train 7 comprising two rear wheels 2b (also visible in FIG. 2).

A structure that is, in this case, an elongate board that extends over the entire length of the vehicle and serves as a contact surface for the feat of the user. The rear wheel train 7 is attached to the rear of the structure 3, while the wheel motor is attached to the front by means of a casing from which a portion of the front wheel projects;

The front wheel 2a has an oval profile (visible in FIG. 2) in a cross-section plane including its wheel rotation axis so as to enable the structure to pivot around its longitudinal axis while keeping a surface substantially constantly in contact with the ground.

The rear wheel train 7 is such that it enables the structure to be tilted with respect to the ground according to this same longitudinal axis and such that it orients the wheels with respect to this longitudinal axis according to the angle of tilt of the structure 3 with respect to the ground, thus enabling the direction of movement of the vehicle on the ground to be changed.

The vehicle comprises means for managing the power supply of the motor 5 comprising electric accumulators or electric energy generating means such as a fuel cell.

Preferably, the power supply management means 5 are placed in the casing so as to be protected. The wheels are oriented so as to roll on the ground while keeping an upper face 9 of the structure oriented upward.

A portion of this upper face constitutes a first contact area 6a for the feet of the user and has a specific sensitivity conferred by means for detecting the presence J of a user on the vehicle. This first area 6a extends over an entire rear portion of the upper face 9 and constitutes a major portion of this upper face.

A second sensitive contact area 6b consists of a first plate 8a extending over a front left-hand portion of the upper face 9.

A third sensitive contact area 6c is constituted by a second plate 8b extending over a front right-hand portion of the upper face 9. The plates 8a and 8b are coplanar and parallel to the major portion of the upper face surface 9.

Each plate 8a, 8b is preferably covered by an adherent layer reducing the user's risk of slipping. Such a layer is necessary because a plate is preferably made of a relatively rigid material such as a metal such as aluminum, and this type of material can be slippery.

An intermediate contact area 6d extends between the second and third contact areas 6b and 6c so as to enable a foot to be placed without it being in contact with areas 6b and 6c. This intermediate area can be constituted by a longitudinal portion of the first contact area, as shown in FIG. 1.

Each of the plates 8a, 8b is assembled to the upper face 9 of the structure so as to be mobile with respect to said face according to contacts applied on each of the plates 8a, 8b. In this case, each assembly is produced so that the movement of a plate with respect to the upper face 9 is less than 1 centimeter. Such a plate assembly is produced by a layer of rubber that is assembled securely to the structure 3 at the level of at least one portion of the intermediate contact area 6d. Outside of the intermediate contact area 6d, this rubber layer remains mobile with respect to the structure 3. The plates 8a and 8b are respectively assembled to portions of the rubber layer located respectively on the sides of the intermediate contact area 6d. A first sensor 10a of at least one physical parameter representing forces applied on the plate 8a is placed between the plate 8a and the structure 3 and preferably passes into an opening formed through the rubber layer. A second sensor 10b of at least one physical parameter representing forces applied on the plate 8b is placed between the plate 8b and the structure 3 and preferably passes into an opening formed through the rubber layer.

In this way, each sensor can sense/measure a user contact on a corresponding plate forming one of the second or third contact areas without being disturbed by contacts produced in other contact areas.

Each of the sensors 10a, 10b is preferably a pressure sensor.

As indicated above, the vehicle also comprises a sensor J also called means for detecting the presence of a user, or vehicle load sensor. This sensor J is preferably produced by means of a sensor for sensing a bend in the structure 3 because it enables the presence of a user on the structure 3 to be detected via a bend in the latter. This bend varies as a function of the user's weight and the contact areas. For this, the parameterization of the vehicle will be performed so that the user will position his or her feet in the first contact area 6a, opposite a transverse axis of the vehicle passing through the sensor J.

Each of these sensors 10a, 10b and J is connected to the power supply management means 5 by a specific conductor passing through the structure 3 via at least one perforation, with each at least one perforation leading into the casing that receives the wheel motor. This positioning of said at least one perforation enables the connectors between the sensors and the power supply management means 5 to be protected so that said connectors are not accessible from outside the vehicle. Preferably, the conductors of the sensors pass through the same perforation, thereby reducing the risk of mechanical weakening of the structure associated with the perforation.

Preferably, each sensor 10a or 10b is placed in a front peripheral area of the plate that corresponds to it so that, for a constant contact of the user applied on a given plate, the pressure detected by the sensor corresponding to this plate increases with the proximity between the contact point and the sensor. The plate thus serves as a lever for amplifying the force applied on the sensor, and the preponderance of a user command is dependent on its point of application on the plate. Preferably, the power supply management means 5 are programmed so that the greater the force detected by the sensor 10a or 10b is (and therefore the greater this contact is and/or the more this contact is applied on the front of the plate and therefore of the vehicle), the greater the user's desired target speed is, on a target speed scale ranging from 0 to vmax, which is the greatest authorized target speed (this point will be explained in detail below).

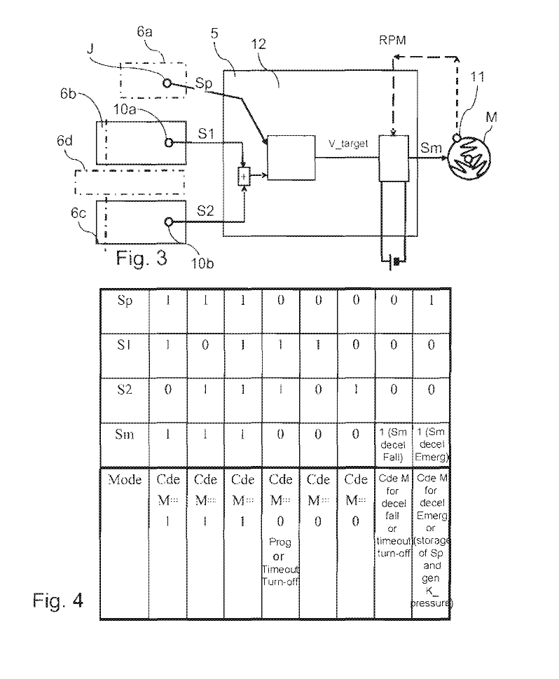

As shown in FIG. 3, the forces applied on the first area 6a are indirectly detected via the structure bend sensor J, which also generates a signal Sp of the presence of the user on the board.

The sensor 10a, which detects contacts produced in the second contact area 6b, generates a signal S1 representing forces in this second area.

The sensor 10b, which detects contacts produced in the third contact area 6c, generates a signal S2 representing forces in this second area 6b.

Signals Sp, S1 and S2 are transmitted to the power supply management means 5, which have a function for summing signals S1 and S2 so that they take into account the sum of these signals in order to generate the power supply signal of the motor Sm.

The table of FIG. 4 comprises eight columns each giving the mode of operation of the vehicle as a function of types of signals Sp, S1, S2 transmitted by the respective sensors J, 10a and 10b.

By convention:
in line Sp, “1” means that there is a detection of the presence of a user on the vehicle, and “0” means that there is no presence detection;
in line S1, “1” means that there is a detection of contact on the second sensitive contact area 6b, and “0” means that there is no detection of contact on this area;
in line S2, “1” means that there is a detection of contact on the third sensitive contact area 6c, and “0” means that there is no detection of contact on this area;
in line Sm, “1” means that a signal for power supply of the motor is generated, and this signal can be an acceleration or optionally a deceleration signal according to the speed of the vehicle with respect to the target speed vtarget; the notation “0” means that no signal is transmitted to the motor; the notation “Sm decel Fall” means that the signal transmitted to the motor is a deceleration signal in the event of a fall leading to a deceleration curve for which maximum braking (maximum deceleration) is programmed; finally, the notation “Sm decel Emerg” means that the signal transmitted to the motor is a deceleration signal ordered by contacts of the user only in the first sensitive area and by the absence of contact in the second and third sensitive areas, and the signal transmitted to the motor is then a deceleration signal in the event of an emergency leading to a deceleration curve for which the maximum braking in the event of an emergency (maximum deceleration in the event of an emergency) is programmed.

In summary, in all of the cases in which a presence signal Sp and at least one of the contact signals S1 or S2 are detected, a motor command signal Sm is generated, which is set according to the target speed v_target determined by summation of S1 and S2 and by means of a sensitivity coefficient K_pressure of sensors 10a, 10b, which is predetermined and recorded, and the motor command Cde M is then “1”.

If a presence signal Sp (Sp=1) is detected and no contact on areas 6b and 6c is detected, i.e. in the absence of the two contact signals S1 and S2, the signal “Sm decel Emerg” is generated if the motor is rotating, or the signal Sp is stored and the sensitivity coefficient K_pressure is determined and stored as a function of the maximum value(s) of S1 and/or S2 measured in order to determine the maximum contact pressure considered by the user to be a maximum acceleration command. Preferably, said generation of the sensitivity coefficient K_pressure is authorized only if the vehicle was previously in programming “Prog” mode.

The switching of the vehicle to programming mode is performed if the motor does not rotate and if the presence signal is at “0” when the signals S1 and S2 are at “1”. The motor command is then deactivated “Cde M=0” for a given duration enabling the user to mount the vehicle so as to be detected by the sensor J, which generates a signal Sp representing the weight of the user on the vehicle. Said sensitivity coefficient K_pressure is then calculated according to the maximum values of S1 and/or S2 then stored. This step constitutes a parameterization of the vehicle prior to its use.

If no presence signal Sp (Sp=0) is detected and no contact is detected on areas 6b and 6c, i.e. in the absence of the two contact signals S1 and S2 (“S1=0 and S2=0”), a signal “Sm decel Emerg” is generated if the motor is rotating, or a timeout is activated, which causes the vehicle to be turned off if no signal Sp, S1, S2 in which motor rotation movement is detected before the end of the timeout.

In a particular embodiment of the invention, it is possible to obtain a sensitive contact area by using at least one mat for detecting pressures applied on said mat and suitable for transmitting, to said power supply management means, a signal representing:
the intensity of the force applied on this contact area; and
the location of the application of force on this contact area.

In a particular embodiment, a single detector mat is used, which is arranged on the upper face of the structure, with the vehicle comprising means for causing the motor command signal to vary according to said signal representing the intensity of the force applied on this contact area and the location of the application of force on this contact area. In this embodiment, the power supply management means of said at least one electric motor are suitable for identifying the contact areas on which the contacts are detected among the first and/or second and/or third sensitive contact areas of said mat.

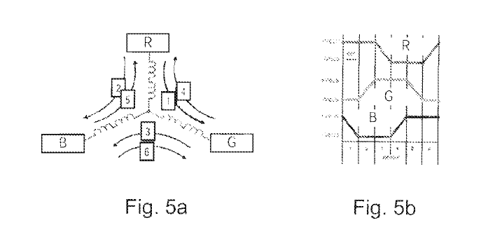

The motor chosen for implementation of the vehicle is a “brushless” motor, i.e. coal-free, and comprises three coils having a common terminal. As shown in FIGS. 5a and 5b for a motor rotation, each coil is supplied for one-third of a rotation with a power supply start offset between two coils of one-sixth of a rotation.

It is noted that each coil is non-powered for around ⅔ of a rotation and remains non-powered for ⅓ of a rotation. For reasons of cost and reliability, a non-powered coil is used as a detector of the motor rotation speed and therefore as means for measuring 11 a physical parameter representing the current speed RPM.

The rotor of the motor consists of a permanent magnet, and the stator includes a plurality of coils (in this case, three) geometrically regularly distributed around the motor. To obtain a rotating magnetic field, it is then suitable to successively supply power to these windings. The rotation speed and the torque supplied are then dependent on the phasing in time of the power supply switching of these coils, with this phasing being determined by the power supply signal Sm. The means for measuring 11 the current speed RPM_MIN make it possible to ensure the successful operation of the motor because they make it possible to determine a position of the axis of the motor, and, thus, it is possible to keep the magnetic field synchronized with the position of the rotor.

The algorithm for generating the power supply signal of the motor Sm uses this winding as a sensor 11 and the rotation position of the motor axis is determined by measuring the counter-electromotive force at the terminals of the winding when it is not powered.

With this method, it is possible to do without the position sensor on the output shaft intended solely for this purpose. However, due to residual magnetism phenomena and excessive measurement times, this type of “sensor-free” control of the motor is reliable over a limited rotation speed interval. This interval is between a minimum rotation speed and a maximum speed that is never reached because the power supply signal Sm is intended to keep the rotation speed of the motor below this maximum speed.

Satisfactory operation at low speed is obtained by generating a power supply signal of the motor of which the frequency variation rate is rendered progressive by limiting this frequency variation rate at least until the motor reaches said minimum rotation speed.

Preferably, the power supply management means of the motor 5 comprise a motor control card and a battery-monitoring card.

The motor control card is turned on by the battery-monitoring card via a pressure applied by the user on a specific push-button or by a simultaneous contact on the second and third contact areas when the motor control card is off. The motor control card then generates a control signal for the battery card, causing the voltage to be maintained even if the push-button is released or simultaneous contact with the second and third areas is released. The motor control card then transmits a short on signaling sound, then waits for the contact(s) to be released.

In the event of pressure on a sensor at the time of startup, this short sound is prolonged until the problem is corrected. The wheel is then free and no motor power supply signal is transmitted.

The motor control card automatically turns off the vehicle by cutting the signal for maintaining the power supply preceded by the transmission of two short sounds.

The turn-off is initiated:
when contact on the push-button is detected for a duration greater than a value T_BPOFF (3 seconds) and the condition of non-presence of the user on the board is detected at the end of the timeout; or
when there is non-detection of the presence of the user on the board for a duration greater than a value T_AUTOOFF (20 seconds).

### A) Initialization

The motor control card, during turn-on, executes the following functional programming procedure:
reading of the binary value of the stress gauge J, corresponding by definition to the average level of non-presence of the user (value denoted gauge_zero). For this, a plurality of successive measurements are performed quickly and averaged;
positioning of the set point speed v_setpoint to 0;
positioning of the sensitivity of the pressure sensors k_pressure to the last value saved in the non-volatile memory (or by default to the manufacturer's setting).

### B) Detection of the Presence of a User on the Board (the Vehicle is Preferably a Skateboard)

The presence of a user on the board is detected by reading the binary value of the stress gauge J, via the following condition:
detection of a person on the board if:

(gauge−gauge_zero>V_GAUGE) in which V_GAUGE is a predetermined value.

If this equation is not verified, there is considered to be a non-detection of a person on the board.

### C) Programming “PROG” Mode

After the motor control card has been turned on, it is possible, for a maximum time of value T_MAXPROG (typically 20 s), to enter the programming mode via the following two simultaneous conditions:
non-detection of a person on the board, and
value read on the pressure sensors 10a, 10b greater than a value V_PROG_PMIN, which therefore means that a manual pressure is exerted by the user.

Upon entrance into this “Prog” mode, a sound signal (three short sounds) is generated. The user must then mount the board. If no mounting of the board is detected after a time T_PROG_MAX, then the programming mode will be abandoned (transmission of a long sound).

If a mounting of the board is detected via the signal Sp generated by the gauge J, then the motor control card must execute a series of measurements on the pressure sensors 10a, 10b for a time of value T_PROG_DURATION. A the end of this time lapse, an average of the highest-amplitude measurements is obtained, and is considered to be the new reference for the maximum speed command v_pressure_max and is stored in a non-volatile memory. The programming mode is then quit (transmission of four short sounds).

### D) Target Speed

The target speed v_target is set by the sum v_pressure of the values read on the two pressure sensors 10a, 10b located at the front of the board, and proportionally to the maximum value v_pressure_max defined by the programming step. A minimum threshold V_PMIN of the signals S1 and S2 enables a zero value to be obtained when the pressure is low or zero. In the event of non-detection of a user, the target value is set to zero (automatic stopping of the board in the event of a fall):
if there is non-detection of a user, i.e. if Sp=0, then v_target=0 and Sm=deceleration_maxi=DECEL_FALL
otherwise, if a user is detected, i.e. if Sp=1 and if (100×v_pressure/v_pressuremax<V_PMIN) then v_target=0 and Sm=deceleration_maxi=DECEL_EMERGENCY
finally, if a user is detected with Sp=1, then v_target=100×v_pressure/v_pressuremax is calculated by taking care to limit v_target so that the acceleration value associated with the variation in time of v_target is less than a predetermined value of deceleration_maxi=DECEL_STD and less than a predetermined value of acceleration_maxi=ACCEL_STD.

### E) Speed Set Point

By taking into consideration the target speed v_target and the maximum accelerations and decelerations authorized and prerecorded (these values ensure that synchronization is maintained between the signal Sm and the rotor of the motor, in particular at low speed) acceleration_maxi and deceleration_maxi, the motor control card causes the speed set point v_setpoint over time to change so as to move toward the target speed without causing the user to accelerate too much. The motor command signal is determined on the basis of the set point speed thus calculated in order to obtain the motor speed v_setpoint.

For this, at each time interval, the actual speed set point is compared with the target speed, and is increased or decreased depending on the case:
if (v_setpoint>v_target), then v_setpoint=min(v_target, v_setpoint+acceleration_maxi×dt) in which min indicates that the lowest value between the two values (v_target) and (v_setpoint+accleration_maxi×dt) has been chosen;
if (v_setpoint<v_target), then v_setpoint=max(v_target, v_setpoint−deceleration_maxi×dt) in which max indicates that the greatest value between the two values (v_target) and (v_setpoint−deceleration_maxi×dt) has been chosen.

The difference between v_setpoint and v_target is preferably limited to v_target.

### F) Starting Phase

As indicated above, to ensure the starting of the motor, the system has an “open loop” mode, which is intended to apply switching phasings of the RGB phases of Sm in a pre-established manner. The objective is then to bring the rotor of the motor to a speed RPM_MIN (in rotations per minute) that is high enough for the signals associated with the counter-electromotive force to be measurable. Once this speed has been reached, a switch to “slaved” mode is then ordered. A controller belonging to the power supply management means then ensures regulation toward a specified set point speed v_setpoint.

### G) Slowing Phase

During a slowing phase, the speed set point progressively decreases until the closed-loop operation is no longer possible, and the threshold is also at a speed of RPM_MIN (motor rotation speed in rotations per minute). It then switches to “braking” mode. A short-circuit of the windings of the motor is then applied according to a cyclic ratio defining the intensity of the braking.

### H) Management of the Motor

In normal operation, a Motor Control software program run by the motor control card controls the various windings/coils of the motor in real time so as to cause the speed of the motor RPM to move toward a speed v_setpoint. The overall principle is based on a determination of the counter-electromotive force associated with a real speed regulation loop.

### I) Monitoring of the Battery Voltage

The battery voltage (Vbus) is measured periodically by the battery-monitoring card. There are two voltage thresholds triggering two different actions. If the battery voltage goes below a value V_THRESHOLDBAT1 (in this case 18V), then a sound signal (very short sound) is generated every 10 seconds to alert the user.

The second threshold, V_THRESHOLDBAT2 (in this case 14V) is intended to save the battery by preventing a full discharge state. The system generates a very long sound, then performs a stop (slowing phase, then stop) identical to that of an emergency braking mode, then cuts the power supply of the board.

1-13. (canceled)

14. Powered vehicle, including:
front and rear wheels suitable for supporting the vehicle with respect to the ground and for enabling the vehicle to move by rolling;
a structure extending between the front and rear wheels, and over a major portion of a length of the vehicle, which structure is suitable for supporting feet of a user in a standing position on the vehicle;
at least one electric motor driving at least one of said wheels in rotation; and
means for managing an electrical supply of said at least one electric motor, wherein the vehicle comprises at least first and second areas for contact of the feet of the user in the standing position on the vehicle, said second contact area has at least one specific sensitivity and said power supply management means are suitable for generating an electrical power supply signal of said at least one motor that is variable according to the contact detected on said second contact area.

15. Vehicle according to claim 14, wherein said second sensitive contact area extends over at least 20% of the length of said vehicle.

16. Vehicle according to claim 14, where said second sensitive contact area extends over a length between 30% and 60% of the length of said vehicle.

17. Powered vehicle according to claim 14, wherein each of said first and second contact areas has at least one specific sensitivity and said power supply management means are suitable for generating a power supply signal of said at least one motor, which is variable according to a distribution of at least some of a weight of the user on said first and second contact areas.

18. Powered vehicle according to claim 14, wherein characterized in that the second contact area has a sensitivity making possible a measurement of contact force exerted by the user on all or part of said second contact area.

19. Powered vehicle according to claim 14, wherein further comprising a third area for contact of a foot of the user in a standing position on the vehicle, said third contact area having a specific sensitivity, in which the means for managing the power supply of the at least one motor are suitable for causing said power supply signal of said at least one motor to vary according to distribution of at least a part of the weight of the user on at least two of said first, second and third contact areas.

20. Powered vehicle according to claim 19, further comprising an intermediate contact area for the foot of the user located between the second and third areas and having a width at least greater than 5 centimeters.

21. Powered vehicle according to claim 14, further comprising means for detecting the presence of a user on the vehicle, which are suitable for generating a signal for detecting the presence of a user on the vehicle.

22. Powered vehicle according to claim 21, wherein the power supply management means of the at least one motor are suitable, in the event of the detection of the presence of a user on the vehicle and in the event of non-detection of contact of the user on the second contact area, for generating a signal for emergency deceleration of the vehicle so that the at least one motor generates a braking torque of the vehicle at least until the vehicle stops.

23. Powered vehicle according to claim 21, wherein the power supply means of the motor are suitable so that, in the absence of the detection of the presence of the user on the vehicle by said presence detection means, the power supply management means of the at least one motor generate a deceleration signal indicating that the user has fallen, so that the motor generates a braking torque of the vehicle until the vehicle stops.

24. Vehicle according to claim 23, wherein the signals for emergency deceleration and deceleration for a user fall are adapted so that the complete stopping time of the at least one motor is shorter in response to the signal for deceleration for a user fall than in response to the emergency deceleration signal.

25. Powered vehicle according to claim 14, further comprising at least one wheel train to which one of said front or rear wheels of the vehicle belongs, said at least one wheel train being movably mounted with respect to the structure, between right steering and left steering positions of the vehicle, and the mobility of said at least one wheel train being suitable for adopting a steering position according to a tilting position of said structure with respect to the ground on which said vehicle is moving.

26. Powered vehicle according to claim 14, wherein at least one of the contact areas having a specific sensitivity includes a plate defining a contact surface of said at least one contact area, in which said plate being arranged on an upper face of the structure and being mobile with respect to the structure, at least one sensor of at least one physical parameter representing a force applied on said plate is connected to said means for managing the power supply so as to transmit a signal thereto representing a force applied on said plate, and said sensor of at least one physical parameter is placed between said plate and the structure.

27. Method for controlling a powered vehicle according to claim 14, comprising:
a step of measuring a physical parameter representing an intensity of contact on the second contact area; and
a step of generating the power supply signal of said motor, which is dependent on the measured physical parameter and representing an intensity of contact on said second contact area.
